(19) United States
(12) Patent Application Publication
(10) Pub. No.: US 2026/0170710 A1
(43) Pub. Date: Jun. 18, 2026

(54) METHOD, APPARATUS, AND SYSTEM FOR AUTOMATED SPATIOTEMPORAL LAYER GENERATION AND INTEGRATION FOR VISUAL EFFECT COMPOSITION

(71) Applicant: ELECTRONICS AND TELECOMMUNICATIONS RESEARCH INSTITUTE, Daejeon (KR)

(72) Inventors: Min-Ji CHOI, Daejeon (KR); Jeong-Woo SON, Daejeon (KR); Ji-Youn LIM, Daejeon (KR); Sun-Joong KIM, Sejong-si (KR); Won-Joo PARK, Daejeon (KR); Il-Hong SHIN, Daejeon (KR); Sang-Hoon LEE, Daejeon (KR); Alex LEE, Daejeon (KR)

(73) Assignee: ELECTRONICS AND TELECOMMUNICATIONS RESEARCH INSTITUTE, Daejeon (KR)

(21) Appl. No.: 19/415,981

(22) Filed: Dec. 11, 2025

(30) Foreign Application Priority Data
Dec. 13, 2024 (KR) 10-2024-0185441
Oct. 23, 2025 (KR) 10-2025-0154449

(51) Int. Cl. G06T 11/00; G06T 13/00

(52) U.S. Cl. CPC G06T 11/00; G06T 13/00

(57) ABSTRACT

Disclosed herein are a method, apparatus, and system for automated spatiotemporal layer generation and integration for visual effect composition. The apparatus for automated spatiotemporal layer generation and integration for visual effect composition includes one or more processors, and a memory configured to store a program that is executed by the one or more processors, wherein the one or more processors are configured to receive an input source, generate an alpha matte layer, a mask layer, and an impact layer using generative Artificial Intelligence (AI) based on the input source, and generate a single integrated layer based on the alpha matte layer, the mask layer, and the impact layer.

### CROSS REFERENCE TO RELATED APPLICATIONS

This application claims the benefit of Korean Patent Application Nos. 10-2024-0185441, filed Dec. 13, 2024 and 10-2025-0154449, filed Oct. 23, 2025, which are hereby incorporated by reference in their entireties into this application.

### BACKGROUND OF THE INVENTION

### 1. Technical Field

The present disclosure relates generally to a method, apparatus, and system for automated spatiotemporal layer generation and integration for visual effect composition, and more particularly to a method, apparatus, and system for automated spatiotemporal layer generation and integration for visual effect composition, which generate visual effects used in Visual Effects (VFX) compositing and creation, film production, animation, game development, advertising, and other digital content production.

The present disclosure relates to a method, apparatus and system for automated spatiotemporal layer generation and integration for visual effect composition, which automatically integrate an original image with various effect layers by utilizing a generative Artificial Intelligence (AI) workflow pipeline, and ensure natural visual consistency based on integrated results.

### 2. Description of the Related Art

Conventional visual-effects (VFX) compositing technologies have primarily evolved while focusing on generating visual effects through a process of preprocessing image data and combining layers. These technologies have primarily relied on separating foreground and background, tracking and rendering dynamic objects, and performing tasks based on manually defined masks. A conventional system has been implemented in such a way that a user personally designates the boundaries of objects or the location of special effects, or emphasizes a specific region through various algorithms. To maintain temporal continuity and consistency across video frames, some technologies have attempted to provide more precise results by utilizing an optical flow or a neural network.

However, these conventional technologies are limited in analyzing complicated interaction between objects or in generating automated high-quality effects using spatiotemporal context. In particular, there is difficulty in automating an advanced compositing process in which the operation of objects and environmental characteristics are taken into consideration. Further, because there are many cases where the generation and integration of individual layers are dependent on manual operations, a problem arises in that operational efficiency is low and it is difficult to maintain consistent quality. These limitations lead to an inefficient task process in which operators need to invest significant time and cost, and they become an even greater obstacle in large-scale image/video projects.

### SUMMARY OF THE INVENTION

Accordingly, the present disclosure has been made keeping in mind the above problems occurring in the prior art, and an object of the present disclosure is to provide an method, apparatus, and system for automated spatiotemporal layer generation and integration for visual effect composition, which overcome the limitations of conventional VFX compositing technologies and automatically analyze spatiotemporal context and object-to-object interactions, thus generating and integrating high-quality special effects.

Another object of the present disclosure is to provide a method, apparatus, and system for automated spatiotemporal layer generation and integration for visual effect composition, which automatically generate an alpha matte, an impact layer, and an integrated layer using generative AI based on an original image and input layers, and iteratively learn them to continuously improve composition quality.

A further object of the present disclosure is to provide a method, apparatus, and system for automated spatiotemporal layer generation and integration for visual effect composition, which automatically process complicated effects while maintaining natural interaction between an object and background in an image, thus minimizing manual tasks and guaranteeing high efficiency and quality.

Yet another object of the present disclosure is to provide a method, apparatus, and system for automated spatiotemporal layer generation and integration for visual effect composition, which automate boundary processing between layers and maintain visual consistency, thus reducing a burden of an operator in a VFX compositing process and enabling stable application even to a large-scale image/video project.

Still another object of the present disclosure is to provide a method, apparatus, and system for automated spatiotemporal layer generation and integration for visual effect composition, which may significantly improve working speed compared to conventional schemes, reduce iterative tasks in an effect generation process, and improve the quality of images, thus presenting a new solution that is utilizable in various production environments.

In accordance with an aspect of the present disclosure to accomplish the above objects, there is provided a method for automated spatiotemporal layer generation and integration for visual effect composition, including receiving an input source, generating an alpha matte layer, a mask layer, and an impact layer using generative Artificial Intelligence (AI) based on the input source, and generating a single integrated layer based on the alpha matte layer, the mask layer, and the impact layer.

The input source may include at least one of an original image, a layer, user-input text or a trimap, or a combination thereof.

Generating the alpha matte layer, the mask layer, and the impact layer may include generating the alpha matte layer using a deep-learning model based on the original image and the trimap that are included in the input source.

Generating the alpha matte layer may include when a trimap is not included in the input source, generating the trimap using a segmentation model based on the original image.

Generating the alpha matte layer, the mask layer, and the impact layer may include generating the mask layer based on the original image and the user-input text that are included in the input source.

Generating the mask layer may include generating a caption for each frame included in the original image using a caption generation model, and calculating text-image similarity using a text-image similarity computation model based on the user-input text, the caption, and the frame, and masking a region of interest in the frame based on the calculated text-image similarity.

Generating the alpha matte layer, the mask layer, and the impact layer may include generating the impact layer based on the original image and the user-input text that are included in the input source.

Generating the impact layer may include generating a condition vector by converting the user-input text into a vector format, generating a spatiotemporal feature vector using a video encoder based on the original image, generating combined data by combining the spatiotemporal feature vector with the condition vector, and generating an impact feature using a Text-to-Video (T2V) diffusion model based on the combined data.

Generating the single integrated layer may include aligning the alpha matte layer, the mask layer, and the impact layer with an identical resolution and identical size, and correcting differences in color and brightness between the alpha matte layer, the mask layer, and the impact layer, wherein the alpha matte layer, the mask layer, and the impact layer are integrated at a blending ratio predefined based on the alpha matte layer, thus generating the single integrated layer.

The method for automated spatiotemporal layer generation and integration for visual effect composition may further include providing the single integrated layer as input of the generative AI to perform learning.

In accordance with another aspect of the present disclosure to accomplish the above objects, there is provided an apparatus for automated spatiotemporal layer generation and integration for visual effect composition, including one or more processors, and a memory configured to store a program that is executed by the one or more processors, wherein the one or more processors are configured to receive an input source, generate an alpha matte layer, a mask layer, and an impact layer using generative Artificial Intelligence (AI) based on the input source, and generate a single integrated layer based on the alpha matte layer, the mask layer, and the impact layer.

The one or more processors may be configured to generate the alpha matte layer using a deep learning model based on an original image and a trimap that are included in the input source.

The one or more processors may be configured to, when a trimap is not included in the input source, generate the trimap using a segmentation model based on the original image.

The one or more processors may be configured to generate the mask layer based on the original image and user-input text that are included in the input source.

The one or more processors may be configured to generate a caption for each frame included in the original image using a caption generation model, calculate text-image similarity using a text-image similarity computation model based on the user-input text, the caption, and the frame, and mask a region of interest in the frame based on the calculated text-image similarity.

The one or more processors may be configured to generate the impact layer based on the original image and user-input text that are included in the input source.

The one or more processors may be configured to generate a condition vector by converting the user-input text into a vector format, generate a spatiotemporal feature vector using a video encoder based on the original image, generate combined data by combining the spatiotemporal feature vector with the condition vector, and generate an impact feature using a Text-to-Video (T2V) diffusion model based on the combined data.

The one or more processors may be configured to align the alpha matte layer, the mask layer, and the impact layer with an identical resolution and identical size, and correct differences in color and brightness between the alpha matte layer, the mask layer, and the impact layer, and the alpha matte layer, the mask layer, and the impact layer may be integrated at a blending ratio predefined based on the alpha matte layer, thus generating the single integrated layer.

The one or more processors may be configured to provide the single integrated layer as input of the generative AI to perform learning.

In accordance with a further aspect of the present disclosure to accomplish the above objects, there is provided a program or software stored in a computing device-readable medium, the computing device performing a method including when being executed by one or more processors of the computing device, receiving an input source, generating an alpha matte layer, a mask layer, and an impact layer using generative AI based on the input source, and generating a single integrated layer based on the alpha matte layer, the mask layer, and the impact layer.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a configuration diagram illustrating the configuration of a system for automated spatiotemporal layer generation and integration for visual effect composition according to an embodiment of the present disclosure;

FIG. 2 is a flowchart illustrating a process of performing a method for automated spatiotemporal layer generation and integration for visual effect composition according to an embodiment of the present disclosure;

FIG. 3 is a flowchart illustrating a process of performing an alpha matte layer generation method according to an embodiment of the present disclosure;

FIG. 4 is a flowchart illustrating a flow of an alpha matte algorithm according to an embodiment of the present disclosure;

FIG. 5 is a flowchart illustrating a process of performing a mask layer generation method according to an embodiment of the present disclosure;

FIG. 6 is a flowchart illustrating a process of performing an impact layer generation method according to an embodiment of the present disclosure;

FIG. 7 is a flowchart illustrating a flow of an impact feature extraction algorithm according to an embodiment of the present disclosure; and

FIG. 8 is a diagram illustrating the configuration of a computer system according to an embodiment of the present disclosure.

### DESCRIPTION OF THE PREFERRED EMBODIMENTS

The present disclosure may be variously modified and may have various embodiments, and thus specific embodiments will be illustrated in the attached drawings and described in detail in the detailed description of the disclosure. However, this is not intended to limit the present disclosure to particular modes of practice, and it should be appreciated that all changes, equivalents, and substitutes that do not depart from the spirit and technical scope of the present disclosure are encompassed in the present disclosure.

Detailed descriptions of example embodiments to be described later refer to the accompanying drawings illustrating a specific embodiment as an example. These embodiments are described so that those skilled in the art to which the present disclosure pertains can easily practice the embodiments. It should be understood that the various embodiments are different from each other, but are not necessarily mutually exclusive from each other. For example, specific shapes, structures, and characteristics described here may be implemented in other embodiments without departing from the spirit and scope of the present disclosure in relation to one embodiment. In addition, it should be understood that the location or arrangement of individual components within each disclosed embodiment may be changed without departing from the spirit and scope of the embodiments. Therefore, the detailed description which will be made later is not intended to be taken in a limited sense, and the scope of the example embodiments, if appropriate, is limited only by the accompanying claims, along with all of the scope equivalent to those of the accompanying claims.

It should be noted that similar reference numerals in the drawings are used to designate the same or similar functions throughout various aspects. The shapes, sizes, etc. of elements in the drawings may be exaggerated to make the description clearer. Further, the term “and/or” may include a combination of a plurality of related listed items or any of the plurality of related described items. The terms “part,” “unit,” and “module” used in the present disclosure may include one or more components, and may include software components and/or hardware components.

It will be understood that, although the terms “first” and “second” may be used herein to describe various components, these components should not be limited by these terms. These terms are only used to distinguish one component from other components. For instance, a first component may be referred to as a second component without departing from the scope of the present disclosure. Similarly, the second component may also be referred to as the first component.

It should be understood that, when a certain component is described as being “connected” or “coupled” to another component, the two components may be directly connected or coupled to each other, but there may also be other components interposed between the two components. On the other hand, it should be understood that, when a certain component is referred to as being “directly connected” or “directly coupled” to another component, there are no intervening components between the two components.

The components disclosed in the embodiments are depicted independently to represent different characteristic functions, and this does not imply that each component is implemented as separate hardware or a single software component. Each component is listed and included separately for convenience of explanation, but at least two of the components may be combined into a single component, or one component may be divided into multiple components to perform functions thereof. Embodiments in which components are integrated or separated are also included within the scope of the present disclosure, as long as they do not depart from the essence of the present disclosure.

The terms used in embodiments are used only to describe a specific embodiment, and are not intended to limit the present disclosure. A singular expression includes a plural expression unless a description to the contrary is specifically pointed out in context. In embodiments, it should be understood that the terms “comprise”, “include”, and “have” when used in this specification, specify the presence of stated features, integers, steps, operations, elements, components, and/or combinations of them but do not preclude the presence or addition of one or more other features, integers, steps, operations, elements, components, and/or combinations thereof. That is, in embodiments, when it is said that a specific component is “included”, it may mean that components other than the specific component are not excluded and that additional components may be included in the embodiments of the present disclosure or the scope of the technical spirit of the present disclosure.

In embodiments, the term “at least one” may denote one of numbers equal to or greater than 1, such as 1, 2, 3 and 4. In embodiments, the term “a plurality of” may denote one of numbers equal to or greater than 2, such as 2, 3 and 4.

At least some of components, units or modules described in embodiments may be program modules, and may communicate with an external device or system.

The program modules may include, but are not limited to, a routine, a subroutine, a program, an object, a program component, a data structure, etc., which perform functions or operations according to an embodiment or implement an abstract data type according to an embodiment.

Some components in the embodiments are not essential components that perform intrinsic functions in the present disclosure, but may merely be optional components intended to enhance performance. The embodiments may be implemented to include only the essential components necessary to realize the essence of the embodiments, excluding components used merely for performance enhancement. A structure including only the essential components, excluding optional components used merely for performance enhancement, is also included in the scope of the embodiments.

Hereinafter, embodiments of the present disclosure are described in detail with reference to the accompanying drawings so that those skilled in the art to which the present disclosure pertains can easily practice the present disclosure. In the description of the embodiments, detailed descriptions of known functions or configurations which are deemed to make the gist of the present disclosure obscure will be omitted. Further, the same reference numerals are used to designate the same or similar components throughout the drawings, and repeated descriptions of the same components will be omitted.

FIG. 1 is a configuration diagram illustrating the configuration of a system for automated spatiotemporal layer generation and integration for visual effect composition according to an embodiment of the present disclosure.

Referring to FIG. 1, a system 1 for automated spatiotemporal layer generation and integration for visual effect composition according to the present disclosure may include generative Artificial Intelligence (AI) 5, an input module 10, a layer generation module 20, a layer integration module 30, and an iterative training module 40.

The generative AI 5 may generate layers. The generative AI 5 may include at least one of VFX effect generative AI, a deep learning model, a segmentation model, a caption generation model, a text-image similarity computation model, a text-video similarity model, a Text-to-Video (T2V) diffusion model or a pre-trained Text-to-Video (T2V) diffusion model, or a combination thereof.

The input module 10 may receive an input source. The input module 10 may receive an original image (plate image) and multiple layers to perform VFX compositing. Here, the plate image may be base data that is a reference for a compositing task. Each of the multiple layers may include visual effects such as segmentation, a mask, and a plate image frame. The input module 10 may set essential initial data for a compositing process. Here, the input source may include at least one of a layer including the plate image and the segmentation information, a layer including mask information, or a layer including visual effect information, or a combination thereof.

The layer generation module 20 may generate layers using the generative AI 5 based on the input source. The layer generation module 20 may generate layers using the generative AI 5 based on the input plate image and the layers. The layer generation module 20 may provide the input plate image and the layers as the input of the generative AI 5. The generative AI 5 may automatically generate the mask layer, the alpha matte layer, and an impact generation layer (or impact layer) by analyzing the plate image and the layers that are provided as the input.

The mask layer, the alpha matte layer, and the impact generation layer may individually perform specific roles of VFX. The mask layer may designate an insertion region, the alpha matte layer may adjust boundary transparency, and the impact layer may add visual emphasis effects. The generative AI 5 may enable automated generation of high-quality layers by replacing a conventional manual operation step.

The layer integration module 30 may generate an integrated layer by integrating the layers generated by the layer generation module 20. The layer integration module 30 may generate a final integrated layer by integrating the mask layer, the alpha matte layer, and the impact generation layer that are generated by the layer generation module 20. The final integrated layer may be designed to contain the unique characteristics of the mask layer, the alpha matte layer, and the impact generation layer while allowing the VFX to be smoothly blended with the plate image. The layer integration module 30 may automatically adjust boundary misalignment or visual inconsistencies that may occur during the layer integration process, by which the overall visual completeness of the image may be improved.

The iterative learning module 40 may provide the integrated layer generated by the layer integration module 30 as the input of the generative AI 5 to perform iterative learning. The iterative learning module 40 may perform iterative learning by inputting the integrated layer back to the generative AI 5. Accordingly, the integrated layer may reflect the result of previous learning, and may expand the learning scope of the generative AI 5 by incorporating new visual data. The generative AI 5 may perform iterative learning through the iterative learning module 40, thus continuously enhancing composition quality. In the disclosed embodiment, the iterative learning process may support iterative learning so that high performance is maintained even in various visual conditions through the automated optimization algorithm.

The system 1 for automated spatiotemporal layer generation and integration for visual effect composition according to the present disclosure may be implemented using one or more devices. The input module 10, the layer generation module 20, the layer integration module 30, and the iterative learning module 40 may operate either within a single device or in physically separated devices.

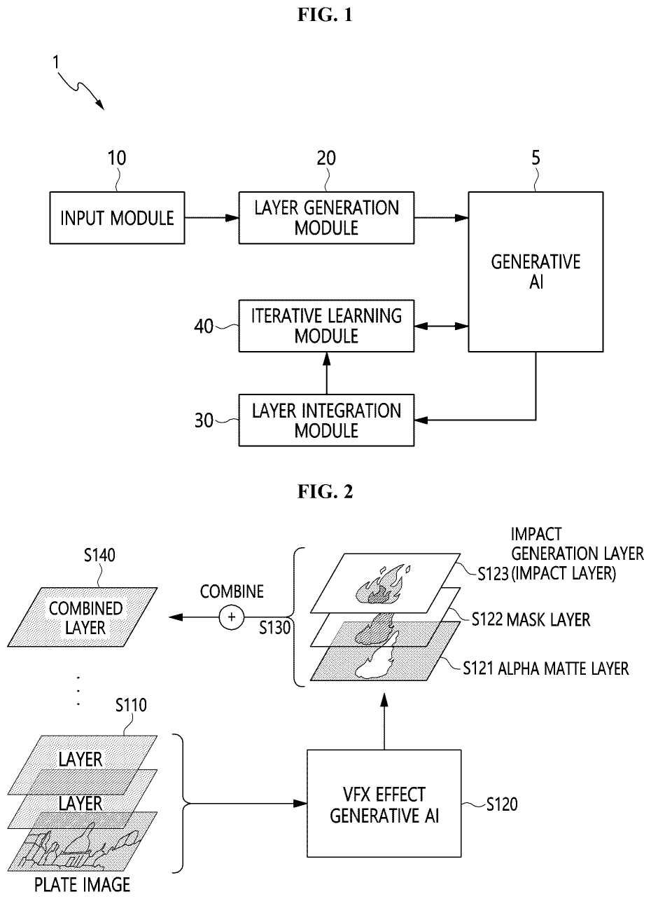

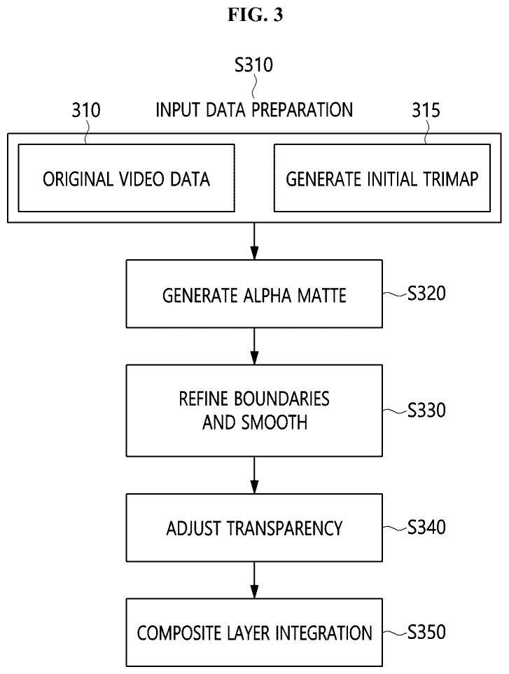

FIG. 2 is a flowchart illustrating a process of performing a method for automated spatiotemporal layer generation and integration for visual effect composition according to an embodiment of the present disclosure.

Referring to FIG. 2, the input module 10 receives an original image (plate image) and layers at step S110. At step S110, the input module 10 may receive multiple layers, each of which may contain visual effects such as segmentation, mask, or original image frames. At step S110, the input module 10 may set essential initial data for a compositing process.

The layer generation module 20 generates layers using the generative AI 5 at step S120. At step S120, a mask layer, an alpha matte layer, and an impact generation layer may be automatically generated by analyzing the plate image and the layers that are input through the generative AI 5. Step S120 may include alpha matte layer generation step S121, mask layer generation step S122, and impact generation layer (impact layer) generation step S123. Step S120 may enable automated generation of high-quality layers by replacing an existing manual operation step.

The layer integration module 30 generates an integrated layer by integrating (or combining) the layers, generated at step S120, at step S130. At step S130, the layer integration module 30 may generate a final integrated layer by integrating the mask layer, the alpha matte layer, and the impact generation layer (or impact layer). The layer integration module 30 may automatically adjust boundary misalignment or visual inconsistencies that may occur during the integration process at step S140, thereby improving the overall visual completeness of the image.

At step S130, the layer integration module 30 may align the layers with each other and may match the sizes of the layers. All layers need to be aligned with the same resolution and the same size. For this, when an input layer does not match the plate image, the layer integration module 30 may perform a resizing and center-alignment process. Also, the layer integration module 30 may selectively use an algorithm for automatically correcting position misalignment that occurs in a boundary region of each layer.

At step S130, the layer integration module 30 may perform alpha matte-based layer blending. The alpha matte may be used to define a blending ratio between individual layers. The respective layers may be naturally blended with the plate image based on an alpha value. In this process, transparency adjustment together with boundary processing may be performed. The layer integration module 30 may utilize a post-processing technique to ensure smoothness in boundary regions.

At step S130, the layer integration module 30 may set priorities between the layers. When the layers overlap each other, the layer integration module 30 may set priorities so that a specific layer is emphasized or rendered with transparency. For example, the alpha matte may function as a highest-priority layer, the mask layer may highlight a specific object, and the impact layer may provide additional visual effects. The layer integration module 30 may dynamically adjust the blending ratio between layers based on these priorities.

At step S130, the layer integration module 30 may correct the colors and brightness of the layers. The layer integration module 30 may apply a histogram matching or color transfer algorithm to reduce differences in color or brightness between layers. By means of this, the colors and brightness between integrated layers may be naturally harmonized, and the final composition result may appear visually consistent.

At step S130, the layer integration module 30 may resolve the boundary misalignment between the layers. The layer integration module 30 may use morphological operations so as to resolve the boundary misalignment that may occur during the layer integration process. By means of this, noise in the boundary regions may be removed, and connections between pixels may be smoothly processed, and thus the quality of the final composition result may be improved.

The morphological operations are techniques that refine boundaries based on the structural characteristics of pixels, and may include operations such as erosion, dilation, opening, and closing. Erosion is effective in removing unnecessary small protrusions or noise by reducing the outer contour of an object, while dilation may be used to connect broken boundaries or fill small gaps by expanding the outer contour of an object. The opening operation may remove small noise while smoothing the boundaries by applying dilation after erosion, whereas the closing operation may compensate for boundary discontinuities and fill small holes inside the object by applying erosion after dilation. The layer integration module 30 may alleviate boundary misalignment between layers and obtain a smoother and more consistent composite result by utilizing such morphological operations.

The iterative learning module 40 provides the integrated layer (or combined layer) generated by the layer integration module 30 to the generative AI 5 as input for iterative learning at step S140. At step S140, the iterative learning module 40 may perform iterative learning by inputting the integrated layer back to the generative AI 5. The iterative learning process at step S140 may support iterative learning so that high performance is maintained even in various visual conditions through the automated optimization algorithm.

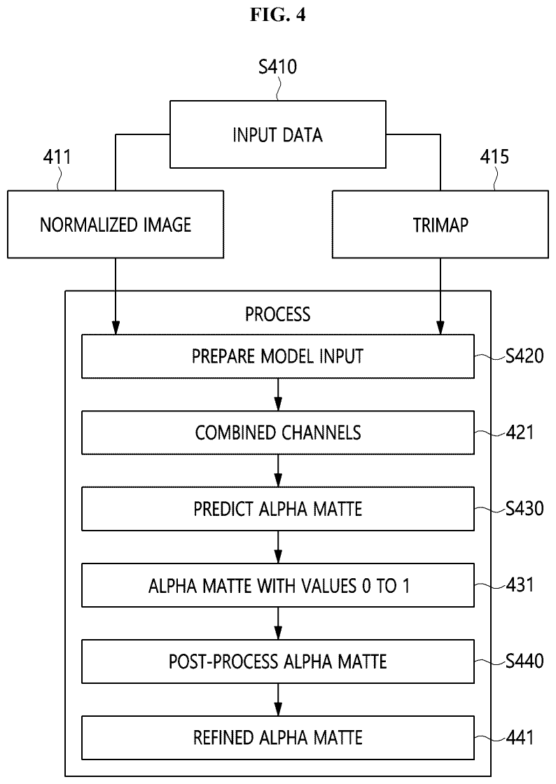

FIG. 3 is a flowchart illustrating a process of performing an alpha matte layer generation method according to an embodiment of the present disclosure.

Referring to FIG. 3, the layer generation module 20 prepares original image data (original video data) required for generating an alpha matte layer at step S310.

FIG. 4 is a flowchart illustrating the flow of an alpha matte algorithm according to an embodiment of the present disclosure.

Referring to FIG. 4, in a procedure at step S310, the layer generation module 20 receives an input source from the input module 10 at step S410. Here, the input source may include at least one of an original image (original video), a layer or a trimap, or a combination thereof.

In the procedure at step S310, the layer generation module 20 prepares the input of the generative AI 5 based on the input source at step S420. At step S420, the layer generation module 20 may generate a normalized image 411 by normalizing the original image as a high-resolution image or video frame to be suitable for the input of a deep learning model. Further, when a trimap 415 is not included in the input source, the layer generation module 20 may generate an initial trimap automatically separated into foreground, background, and an unknown region using a segmentation model.

The trimap may define the foreground, the background, and the unknown region based on the result of segmentation. This data may be used as the input of the deep learning model, and may be normalized on a per-pixel basis at step S420 that is a preprocessing procedure. By means of this, the layer generation module 20 may provide base data that enables the generative AI 5 to learn an accurate alpha matte.

Combined channels 421 may be information channels that are additionally input to the generative AI 5 in addition to existing RGB so as to assist alpha matte prediction. The combined channels 421, which may be input together with RGB video, may include a segmentation map, a trimap or mask, an edge or gradient map, a depth map, and motion or optical-flow information.

The layer generation module 20 generates an alpha matte layer using the generative AI 5 based on the original image data and the trimap at step S320. At step S320, the generative AI 5 receives the trimap and the original image data as input, and predicts the blending ratio of foreground and background as a value between 0 and 1 at step S430. At step S430, an alpha matte including a region (e.g., hair or smoke) in which complex boundary processing is performed may be precisely estimated. The alpha matte is the prediction result of the model, and is represented by continuous pixel values (indicated by 431) within the range of [0, 1]. These values (431) may represent the blending ratio between foreground and background, and may enable smooth transitions even in complex boundary regions. The following Table 1 shows an algorithm for generating the alpha matte.

TABLE 1
Algorithm for Alpha Matte Generation
1. **Initialize Alpha Matte Model**
- Load a pre-trained Alpha Matte Model.
2. **Prepare Model Input**
- Input: Normalized original image and trimap.
- Normalize trimap values (0, 128, 255) to [0, 1].
- Combine normalized image and trimap as input channels.
3. **Predict Alpha Matte**
- Pass the input to the model to predict the alpha matte.
- Output: Alpha matte with values between 0 and 1.
A(x, y) = Model(Iₙₒᵣₘ, Tₙₒᵣₘ), A(x, y) ∈ [0, 1]
Iₙₒᵣₘ : normalized original image
Tₙₒᵣₘ : normalized tri-map
A(x, y) : per-pixel alpha matte value
4. **Post-process Alpha Matte**
- Clip alpha matte values to [0, 1].
- Apply optional noise removal or smoothing.
- Output: Refined alpha matte.

The layer generation module 20 refines and smooths the boundary region of the generated alpha matte at step S330. In a procedure at step S330, the layer generation module 20 may generate a refined alpha matte 441 by removing noise at the boundaries of the alpha matte and smoothly connecting the boundaries using a deep learning algorithm at step S440. Through step S440, the boundary processing quality of the refined alpha matte may be improved, and the visual quality of the matte result may be enhanced. Furthermore, the boundaries of the alpha matte become more natural, and discontinuities between pixels may be reduced even in complex boundaries (e.g., hair or branches).

The layer generation module 20 enables the foreground to be naturally integrated with background by adjusting the transparency value of the refined alpha matte 441 at step S340. At step S340, the range of pixel values may be dynamically scaled, and thus boundary processing between the foreground and the background may be smoothly performed. By means of this process, the transparency of the alpha matte may be more precisely adjusted. The foreground and the background may be blended depending on the alpha matte value, and in this process, the transparency of each pixel may be dynamically adjusted. A region with a lower alpha value may be blended closer to the background, and a region with a higher alpha value may be blended closer to the foreground.

The layer generation module 20 integrates the foreground, the background, and the generated layers based on the alpha matte, subjected to the process at step S340, at step S350. The integrated result may maintain visual consistency with the original image (video), and may provide a high-quality composite result using an automated scheme.

The alpha matte layer generation step S121 illustrated in FIG. 2 may include steps S310 to S350.

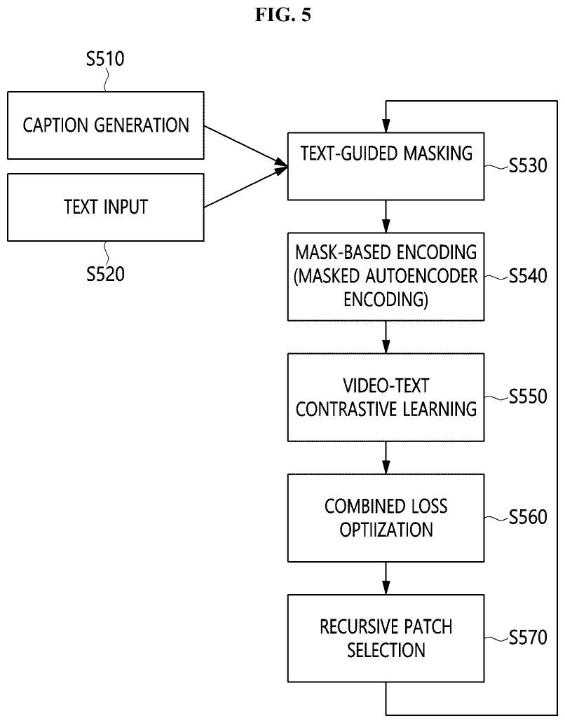

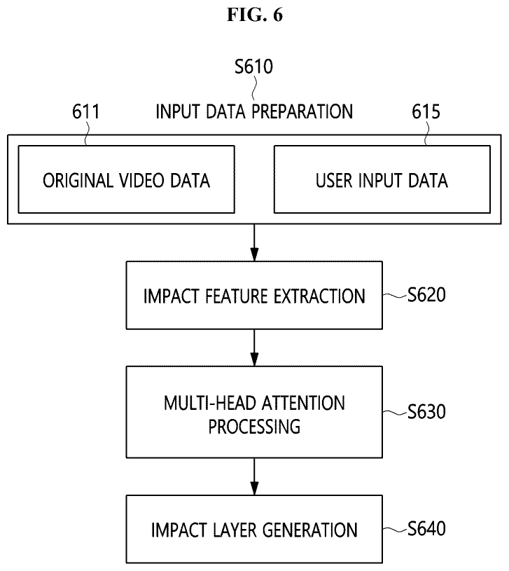

FIG. 5 is a flowchart illustrating a process of performing a mask layer generation method according to an embodiment of the present disclosure.

Referring to FIG. 5, the layer generation module 20 samples key frames from a video and generates captions for each frame using a caption generation model at step S510. The generated captions describe visual contents of each frame in the form of text, and may be used to calculate text-image similarity in subsequent masking and contrastive learning.

The layer generation module 20 defines a specific task target through additional text input provided by the user at step S520. This input may be used to reflect, in the model, the detailed user-customized tasks that are not sufficiently described by the generated captions.

The layer generation module 20 performs text-guided masking at step S530. At step S530, the layer generation module 20 calculates text-image similarity by inputting the generated captions and the additional text input of the user to a text-image similarity computation model. A region of interest may be masked by selecting a patch having higher text-image similarity, and the mask may be used at subsequent mask-based encoding (masked encoding) step S540.

The layer generation module 20 performs mask-based masking at step S540. At step S540, the layer generation module 20 inputs the mask, generated at the text-guided masking step S530, to a mask-based encoder at step S550. A mask-based decoder may reconstruct the masked patch and help the model learn visual features of the region of interest.

The layer generation module 20 performs video-text contrastive learning at step S550. At step S550, the layer generation module 20 reinforces semantic alignment between the text and the video by calculating a contrastive loss between video embedding and text embedding generated by a text-video similarity model. Through the contrastive learning, the masked region may be trained to be more semantically associated with the text.

The layer generation module 20 optimizes a combined loss at step S560. At step S560, the layer generation module 20 combines various loss components to set a single optimization target so that the generative AI 5 is capable of effectively learning the relationship between the visual features of the video and the text. Through this approach, harmony between the visual information of the video and the text may be optimized, and the overall performance of the generative AI 5 may be improved.

The layer generation module 20 optimizes recursive patches at step S570. At step S570, the layer generation module 20 repeatedly selects important patches based on the result of text-guided masking, thereby gradually improving the masking quality. Through the loop, the generative AI 5 may continuously learn patches optimized for a specific task, and may generate an optimal mask.

The mask layer generation step S122 illustrated in FIG. 2 may include steps S510 to S570. In relation to mask layer generation, the prior paper (Fan, David, et al., “Text-Guided Video Masked Autoencoder,” European Conference on Computer Vision, Springer, Cham, 2025.) may be referenced. In the disclosed embodiment, an approach for performing iterative learning and quality improvement is proposed by adding recursive patch selection to the technique described in the prior paper.

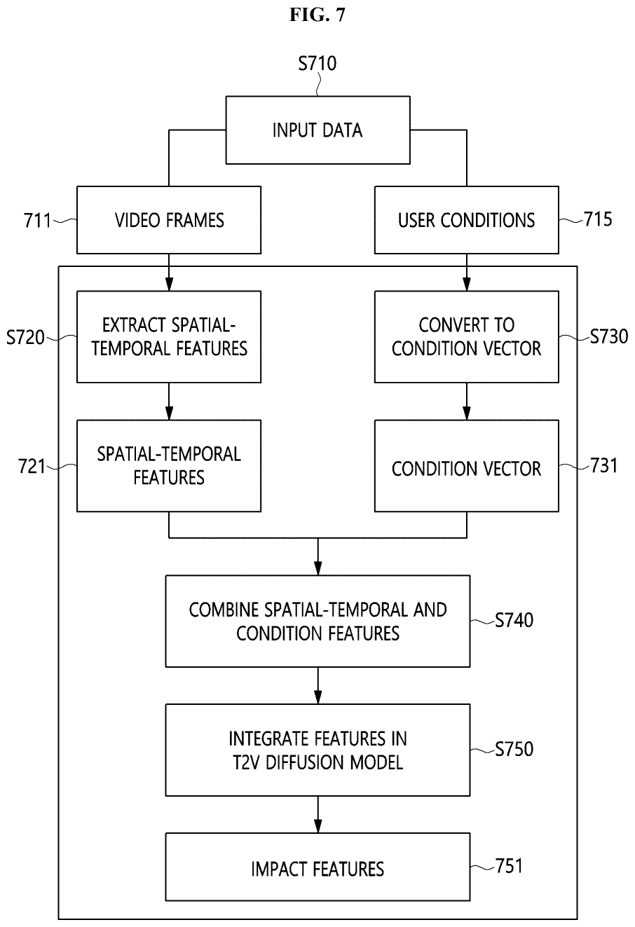

FIG. 6 is a flowchart illustrating a process of performing an impact layer generation method according to an embodiment of the present disclosure.

Referring to FIG. 6, the layer generation module 20 prepares input data to generate an impact layer at step S610. At step S610, the layer generation module 20 may prepare the input data based on an input source.

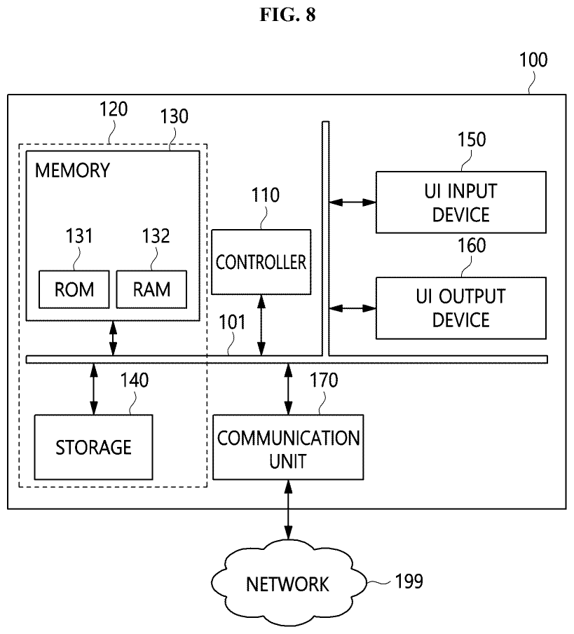

FIG. 7 is a flowchart illustrating a flow of an impact feature extraction algorithm according to an embodiment of the present disclosure.

Referring to FIG. 7, in a procedure at step S610, the layer generation module 20 prepares original video data 611 and user-provided data (user input data) 615 based on the input source to generate an impact layer at step S710. The original video data 611 may be video frames 711 or sequences, and may include spatial features and temporal variations. The video data may be separated into individual frames and stored in an array format. The user input data 615 indicates user conditions 715 for additional control, and may include instructions requested by the user, such as position or intensity.

The user conditions 715 provided by the user are converted into a vector format, and then a condition vector 731 is generated at step S730. At step S730, the layer generation module 20 may preprocess data so that the input conditions (position and intensity) are accurately reflected while maintaining the spatiotemporal continuities of the video frames.

The layer generation module 20 extracts impact features at step S620. At step S620, the layer generation module 20 may extract features required for impact effect by combining the original data and the input information. In a procedure at step S620, the layer generation module 20 identifies spatiotemporal features 721 using a video encoder at step S720. At step S720, the video encoder may extract motion patterns and interaction information between objects from video data, and a camera encoder may additionally reinforce spatial context.

The input user condition 731 is composed of position and intensity values, and is combined with a spatiotemporal feature vector at step S740.

The data combined at step S740 is integrated into Text-to-Video (T2V) diffusion model to generate impact features 751 at step S750. The impact features 751 may indicate a final impact feature vector. The text-to-video diffusion model may receive a text condition (prompt) and generate a video with temporal and spatial consistency. That is, the text-to-video diffusion model may combine various features, such as text, visual information, and temporal information, into a single latent representation, and may then generate a video by controlling sampling during the diffusion process. The following Table 2 shows an algorithm for extracting impact features.

TABLE 2
Algorithm for Extracting Impact Features
1. **Input Data**
- Input:
•Video frame sequence (frames).
•User input conditions (user_conditions).
•Pre-trained T2V Diffusion model (pretrained_t2v_model).
2. **Extract Spatial-Temporal Features**
- Use a video encoder to extract spatial and temporal features.
- Output: spatial_temporal_features = video_encoder.encode(frames).
Fₛₐₚₜᵢₐₗ₋ₜₑₘₚₒᵣₐₗ = VideoEncoder(F_{frames})
F_{frames} : video frame array
Fₛₚₐₜᵢₐₗ₋ₜₑₘₚₒᵣₐₗ : spatiotemporal feature vector
3. **Combine with User Conditions**
- Convert user input conditions (e.g., position, intensity) into a vector and
integrate.
- condition_vector = [position_x, position_y, intensity].
4. **Integrate Features in T2V Diffusion Model**
- Combine spatial-temporal features with user condition vector.
- Pass the combined data to the T2V Diffusion model to generate impact-specific
features.
- Output: impact_features =
t2v_model.integrate_features(spatial_temporal_features, condition_vector).
5. **Output Features**
- Output:
• spatial_temporal_features: Extracted spatial and temporal features.
• impact_features: Final integrated impact features.

The layer generation module 20 processes multi-head attention at step S630. At step S630, the layer generation module 20 may reinforce text conditions (i.e., text-video relationships) required for generating the impact layer using a multi-head attention mechanism. At step S630, the spatial consistency and temporal continuity may be maintained, and data essential for generating the impact layer may be provided.

The multi-head attention mechanism is a method including an operation of processes single attention mechanisms in parallel, as shown in the following Table 3. To achieve spatial consistency, the attention mechanism is applied to an impact-generation area and an area surrounding the impact generation area. To achieve temporal consistency, the attention mechanism applies data to which the spatial consistency mechanism has been applied after serializing the corresponding data into a time-ordered sequence. As a result, semantic context across individual frames may be reinforced while maintaining temporal continuity.

TABLE 3
<Algorithm for Impact Layer Generation using Multi-head Attention>
1. **Initialize Multi-head Attention Mechanism**
- Define a multi-head attention module with multiple heads to process data in
parallel.
2. **Apply Spatial Attention for Consistency**
- Input: Impact area and surrounding area.
- Apply multi-head attention mechanism between the impact areas and their
surrounding area.
- Output: Spatially consistent impact area data.
3. **Serialize Spatially Consistent Data**
- Input: Spatially consistent impact area data
- Serialize input into a temporal sequence to maintain spatial consistency over
time.
4. **Apply Temporal Attention for Consistency**
- Input: Serialized spatial data.
- Apply attention across the temporal sequence to achieve temporal
consistency.
- Output: Impact layer with both spatial and temporal consistency.
5. **Output**
- The final impact layer maintaining both spatial and temporal consistency

The layer generation module 20 extracts an impact layer at step S640. At step S640, the layer generation module 20 may generate the impact layer based on the input data integrated into a pre-trained text-to-video diffusion model. The generated impact layer may simulate various effects, and may optimize harmony between text and the original video. Also, the generated impact layer may also handle the independent generation of impact effects. The process of generating the impact layer is performed based on the data combined with text conditions provided by the user. The input data may integrate spatial and temporal features within the T2V diffusion model, thus enabling accurate simulation of specific effects (e.g., explosions, sparks, light bloom, etc.). The finally generated impact layer may be output in a temporally and spatially harmonized form. The following Equation (1) represents the input value and the output of the T2V diffusion model.

$${L}_{impact} ( t , x , y ) = T 2 V Model ( {F}_{combined} , t ) \qquad ( 1 )$$

Here, L_{impact}(t,x,y) denotes an impact layer value corresponding to spatial coordinates (x, y) at time t, and F_{combined} denotes an input vector in which the spatiotemporal features Fₛₚₐₜᵢₐₗ₋ₜₑₘₚₒᵣₐₗ are combined with the user input conditions.

The impact layer generation step S123 illustrated in FIG. 2 may include steps S610 to S640.

FIG. 8 is a diagram illustrating the configuration of a computer system according to an embodiment of the present disclosure.

Referring to FIG. 8, a system 1 for automated spatiotemporal layer generation and integration for visual effect composition may be implemented as a computer system 100. The computer system 100 may include a bus 101, a controller 110, a storage 120, a user interface (UI) input device 150, a UI output device 160, and a communication unit 170. The storage 120 may include at least one of a memory 130 or a storage 140, or a combination thereof. The controller 110, the memory 130, the storage 140, the UI input device 150, the UI output device 160, and the communication unit 170 may communicate with each other through the bus 101.

When the system 1 for automated spatiotemporal layer generation and integration for visual effect composition is implemented as the computer system 100, the controller 110 may perform functions of a generative AI 5, an input module 10, a layer generation module 20, a layer integration module 30, and an iterative learning module 40. The storage 120 may store an input source and intermediate results of respective modules. In some embodiments, the generative AI 5 may be located in a remote server such as a cloud system, and the controller 110 may utilize the remote generative AI 5. In these embodiments, the communication unit 170 may transmit or receive data to or from a server that provides the service of a diffusion generative AI 5 through the network 199. In some embodiments, the controller 110 may utilize the generative AI 5 stored in the storage 120.

The controller 110 may be a semiconductor device which executes processing instructions stored in the storage 120. The controller 110 may be at least one hardware processor. The controller 110 may be composed of one or more cores, and may include processors for data analysis and deep learning, such as a Central Processing Unit (CPU), a Graphics Processing Unit (GPU), a Digital Signal Processor (DSP), an Application Specific Integrated Circuit (ASIC), a General Purpose Graphics Processing Unit (GPGPU), and a Tensor Processing Unit (TPU).

The controller 110 may perform data processing to train a deep learning network according to an embodiment of the present disclosure by reading a computer program stored in the storage 120.

Program modules may be implemented using instructions or codes that are executed by at least one processor of the controller 110. The program modules may be included in the computer system 100 in the form of an operating system, an application module, and other program modules. The program modules may be physically stored in various known storage devices. Further, at least some of the program modules may be stored in a remote storage device capable of communicating with the communication unit 170.

The controller 110 may execute the instructions or codes of components, units or modules described in embodiments.

The storage 140 may be a storage medium that includes at least one of a nonvolatile medium, a removable medium, a non-removable medium, a communication medium, or an information delivery medium, or a combination thereof.

The memory 130 may include Read Only Memory (ROM) 131 or Random Access Memory (RAM) 132.

The communication unit 170 may transmit or receive data to or from other network entities over the network 199. The communication unit 170 may receive an input source from another electronic device or server. The communication unit 170 may be a network interface. Here, the network 199 may be a broadcasting network, a private network or the Internet, and may include a wired network or a wireless network. The network 199 may refer to one or more parts of a network that can be an ad hoc network, intranet, extranet, Bluetooth, ZigBee, Virtual Private Network (VPN), Local Area Network (LAN), Wireless LAN (IEEE 802.11b, IEEE 802.11a, IEEE 802.11g, IEEE 802.11n), Wireless Broadband (WiBro), Wide Area Network (WAN), Wireless WAN (WWAN), Metropolitan Area Network (MAN), the Internet, a portion of the Internet, a portion of a Public Switched Telephone Network (PSTN), a Plain Old Telephone Service (POTS) network, a cellular telephone network, a wireless network, a Wi-Fi® network, other types of networks, or any combination of two or more of such networks. Further, the network 199 may also refer to one or more parts of a network that is connected to other types of networks. For example, the network or a part of the network may include a wireless or cellular network, and connection may be Code Division Multiple Access (CDMA) connection, Global System for Mobile communications (GSM) connection, or other types of cellular or wireless connections. In this example, connection may be implemented using any of various types of data transmission technologies, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation (4G) wireless networks, Universal Mobile Telecommunications System (UMTS), High Speed Packet Access (HSPA), Worldwide Interoperability for Microwave Access (WiMAX), Long Term Evolution (LTE) standards, other technologies defined by various standard-setup organizations, other long-distance protocols, or other data transmission technologies.

In the above-described embodiments, when applying specific processing to a specific target, a specific condition may be required. In the case where it is described that the specific processing is performed under a specific determination, when it is described that the determination of whether the specific condition is satisfied is made based on a specific coding parameter, or that a specific determination is made based on a specific coding parameter, such coding parameters may be construed as being replaceable with other coding parameters. In other words, the coding parameter influencing the specific condition or the specific determination may be regarded as being exemplary, and it may be understood that combinations of one or more other coding parameters in addition to the specified coding parameter perform the function of the specified coding parameter.

In the above-described embodiments, although the methods have been described as a series of steps or units, based on flowcharts, the present disclosure is not limited by the order of the steps, and some steps may occur as steps different from the above-described steps or in an order different from that of the above-described steps, or simultaneously with the above-described steps. Further, those skilled in the art will understand that the steps shown in the flowchart are not exclusive, and that other steps may be included, or one or more of the steps in the flowchart may be omitted without departing from the scope of the present disclosure.

The above-described embodiments include examples in various aspects. Although not all possible combinations for indicating various aspects can be described, those skilled in the art will recognize that additional combinations other than the explicitly described combinations are possible. Therefore, it may be appreciated that the present disclosure includes all other replacements, changes, and modifications belonging to the accompanying claims.

The above-described embodiments of the present disclosure may be implemented in the form of program instructions that can be executed through various computer components and may be recorded in a computer-readable recording (storage) medium. The computer-readable recording medium may include program instructions, data files, and data structures, either solely or in combination. The program instructions recorded on the computer-readable recording medium may be specifically designed and configured for the present disclosure, or may be disclosed and available to those skilled in computer software fields.

The computer-readable recording medium may include information used in embodiments according to the present disclosure. For example, the computer-readable recording medium may include a bitstream, and the bitstream may include information described in embodiments of the present disclosure.

The bitstream may include computer-executable code and/or program. The computer-executable code and/or program may include pieces of information described in the embodiments, and may include syntax elements described in the embodiments. In other words, the pieces of information and syntax elements described in the embodiments may be regarded as a computer-readable code in the bitstream, and may be regarded as at least part of the computer-executable code and/or program represented by the bitstream.

The computer-readable recording medium may include a non-transitory computer-readable medium.

Examples of the computer-readable recording medium include hardware devices specially configured to store and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of program instructions include not only machine language code created by a compiler but also high-level language code that can be executed by a computer using an interpreter or the like. The foregoing hardware devices may be configured to operate as one or more software modules in order to perform processing according to the present disclosure, and vice versa.

In accordance with a method, apparatus, and system for automated spatiotemporal layer generation and integration for visual effect composition according to the present disclosure, visual effects may be automatically generated and applied in films, advertising, and VFX industry without complex manual operations.

The present disclosure may maintain consistency with visual effects of an input image and produce a final composite layer by automatically generating and combining visual-effect layers (such as alpha matte, mask, and impact-generation effect layers) using generative AI, thus removing repetition of conventional manual tasks, improving visual quality between objects and effects, simplifying a complex image production pipeline and reducing the number of required datasets, with the result that working time may be shortened and productivity may be maximized.

As the final composite layer is designed to be re-trainable in a single layer combination model, the present disclosure may expand the learning scope of the model to include new visual data, and may continuously enhance compositing quality.

Ultimately, the present disclosure may significantly improve the efficiency of digital content production and enable new creative possibilities in diverse production environments.

While the present disclosure has been described above with reference to specific details such as detailed components, limited embodiments, and drawings, these have been provided merely for the purpose of facilitating a more comprehensive understanding of the disclosure. The present disclosure is not limited to the above-described embodiments, and those skilled in the art to which the present disclosure pertains can make various changes and modifications based on the description thereof.

Accordingly, the spirit of the present disclosure should not be construed as being limited to the described embodiments, and the accompanying claims and all modifications and variations that are made equally or equivalently to the accompanying claims may fall within the scope of the spirit of the present disclosure.

As described above, in the method, apparatus, and system for automated spatiotemporal layer generation and integration for visual effect composition according to the present disclosure, the configurations and schemes in the above-described embodiments are not limitedly applied, and some or all of the above embodiments can be selectively combined and configured so that various modifications are possible.

What is claimed is:

1. A method for automated spatiotemporal layer generation and integration for visual effect composition, comprising:
receiving an input source;
generating an alpha matte layer, a mask layer, and an impact layer using generative Artificial Intelligence (AI) based on the input source; and
generating a single integrated layer based on the alpha matte layer, the mask layer, and the impact layer.

2. The method of claim 1, wherein the input source includes at least one of an original image, a layer, user-input text or a trimap, or a combination thereof.

3. The method of claim 1, wherein generating the alpha matte layer, the mask layer, and the impact layer comprises:
generating the alpha matte layer using a deep-learning model based on the original image and the trimap that are included in the input source.

4. The method of claim 3, wherein generating the alpha matte layer comprises:
when a trimap is not included in the input source, generating the trimap using a segmentation model based on the original image.

5. The method of claim 1, wherein generating the alpha matte layer, the mask layer, and the impact layer comprises:
generating the mask layer based on the original image and the user-input text that are included in the input source.

6. The method of claim 5, wherein generating the mask layer comprises:
generating a caption for each frame included in the original image using a caption generation model; and
calculating text-image similarity using a text-image similarity computation model based on the user-input text, the caption, and the frame, and masking a region of interest in the frame based on the calculated text-image similarity.

7. The method of claim 1, wherein generating the alpha matte layer, the mask layer, and the impact layer comprises:
generating the impact layer based on the original image and the user-input text that are included in the input source.

8. The method of claim 7, wherein generating the impact layer comprises:
generating a condition vector by converting the user-input text into a vector format;
generating a spatiotemporal feature vector using a video encoder based on the original image;
generating combined data by combining the spatiotemporal feature vector with the condition vector; and
generating an impact feature using a Text-to-Video (T2V) diffusion model based on the combined data.

9. The method of claim 1, wherein:
generating the single integrated layer comprises:
aligning the alpha matte layer, the mask layer, and the impact layer with an identical resolution and identical size; and
correcting differences in color and brightness between the alpha matte layer, the mask layer, and the impact layer,
the alpha matte layer, the mask layer, and the impact layer are integrated at a blending ratio predefined based on the alpha matte layer, thus generating the single integrated layer.

10. The method of claim 1, further comprising:
providing the single integrated layer as input of the generative AI to perform learning.

11. An apparatus for automated spatiotemporal layer generation and integration for visual effect composition, comprising:
one or more processors; and
a memory configured to store a program that is executed by the one or more processors,
wherein the one or more processors are configured to:
receive an input source, generate an alpha matte layer, a mask layer, and an impact layer using generative Artificial Intelligence (AI) based on the input source, and generate a single integrated layer based on the alpha matte layer, the mask layer, and the impact layer.

12. The apparatus of claim 11, wherein the one or more processors are configured to generate the alpha matte layer using a deep learning model based on an original image and a trimap that are included in the input source.

13. The apparatus of claim 12, wherein the one or more processors are configured to, when a trimap is not included in the input source, generate the trimap using a segmentation model based on the original image.

14. The apparatus of claim 11, wherein the one or more processors are configured to generate the mask layer based on the original image and user-input text that are included in the input source.

15. The apparatus of claim 14, wherein the one or more processors are configured to generate a caption for each frame included in the original image using a caption generation model, calculate text-image similarity using a text-image similarity computation model based on the user-input text, the caption, and the frame, and mask a region of interest in the frame based on the calculated text-image similarity.

16. The apparatus of claim 11, wherein the one or more processors are configured to generate the impact layer based on the original image and user-input text that are included in the input source.

17. The apparatus of claim 16, wherein the one or more processors are configured to generate a condition vector by converting the user-input text into a vector format, generate a spatiotemporal feature vector using a video encoder based on the original image, generate combined data by combining the spatiotemporal feature vector with the condition vector, and generate an impact feature using a Text-to-Video (T2V) diffusion model based on the combined data.

18. The apparatus of claim 11, wherein:
the one or more processors are configured to align the alpha matte layer, the mask layer, and the impact layer with an identical resolution and identical size, and correct differences in color and brightness between the alpha matte layer, the mask layer, and the impact layer, and
the alpha matte layer, the mask layer, and the impact layer are integrated at a blending ratio predefined based on the alpha matte layer, thus generating the single integrated layer.

19. The apparatus of claim 11, wherein the one or more processors are configured to provide the single integrated layer as input of the generative AI to perform learning.

20. A program or software stored on a medium readable by a computing device, the program or software being configured to cause the computing device, when executed by one or more processors of the computing device, to perform a method comprising:
receiving an input source;
generating an alpha matte layer, a mask layer, and an impact layer using generative AI based on the input source; and
generating a single integrated layer based on the alpha matte layer, the mask layer, and the impact layer.
